(19) United States
(12) Patent Application Publication
(10) Pub. No.: US 2005/0193648 A1
(43) Pub. Date: Sep. 8, 2005

(54) Security screening system

(76) Inventors: Christian Paul Klein, Cave Creek, AZ (US); Michael Andrew Dorsey, Dallas, TX (US)

Correspondence Address: FISH & RICHARDSON P.C., 1717 MAIN STREET, SUITE 5000, DALLAS, TX, 75201, US

(21) Appl. No.: 10/788,601

(22) Filed: Feb. 27, 2004

(51) Int. Cl. E04H 3/02; E04H 6/42; E06B 7/32

(52) U.S. Cl. 52/174; 109/19

(57) ABSTRACT

A security screening system includes a screening queue beginning at a sterile gateway and a tray slide that includes a sidewall and a support surface. The tray slide is adjacent to the screening queue and delivers trays to screening subjects in the screening queue. The security screening system may include multiple screening queues.

### TECHNICAL FIELD

This invention relates to security screening, and more particularly to streamlining processes for conducting security inspections.

### BACKGROUND

Security at airports, train terminals, bus stations, schools, government buildings and private buildings has become progressively more stringent. More and more buildings require increased security measures to prevent patrons from introducing unauthorized items into the controlled location. Individuals required to undergo security screening often become agitated at the length of time required to stand in a line to be screened by security personnel. Additionally, current security screening systems have a very small area for divestment. One source of agitation is the efficiency of the security screening process. Another source of agitation is the requirement to divest—and wait for others to divest—while waiting to pass through a security-screening device. Yet another deficiency in current screening systems is the limited surface area upon which screening subjects may place screening trays, or their divested articles. On many occasions, delays in security screening result from inefficiency associated with providing screening trays. Often, screening subjects do not have an opportunity to divest until reaching the screening device or screening area. Security screening personnel often require passengers or others undergoing screening to remove certain predetermined items of clothing and baggage, such as metal items, for example, into a container that is passed through a screening device that allows an operator to view the contents. Screening subjects often have to wait for security personnel to deliver trays to the divestment area before divestment, thus further delaying the divestment and security screening process.

### SUMMARY

In one implementation, a system for security screening includes a passenger screening queue beginning at a sterile gateway and a tray slide positioned adjacent to the screening queue. The tray slide has a sidewall, a receiving portion, and a delivery portion. The tray slide is adaptable to deliver a tray to a passenger in the screening queue.

In another implementation, a system for security screening includes a tray slide adapted to transport an article from a sterile area to a non-sterile area. The sterile area defines a portion of an access-controlled location, and entry to the sterile area requires passage through a detection device. A screening queue that defines a path from the non-sterile area to the sterile area is adjacent to the tray slide.

In yet another implementation, a method for providing security screening includes establishing a first screening that has a start point and passes through a sterile threshold to direct passengers from a non-sterile area to a sterile area. The sterile area includes a portion of an access-controlled area. Access to the sterile area requires screening for prohibited items through the sterile threshold. The method also includes positioning a tray slide that has a sidewall adjacent to a divestment table, placing trays into the return tray, and facilitating the movement of the trays to the start point of the screening queue.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a perspective view of a security system.

FIG. 1B is a side view of a security system according to FIG. 1A.

FIG. 2 is a perspective view of a portion of a tray slide of the security system of FIG. 1A mounted to a platform.

FIG. 3 is a perspective view of an alternative implementation of the tray slide of FIG. 1A.

FIG. 4 is a perspective view of an alternative implementation of the tray slide of FIG. 1A.

FIG. 5 is a perspective view of an alternative implementation of the tray slide of FIG. 1A.

FIG. 6 is a flow chart illustrating a method for a security system.

FIG. 7A is a side view of an alternate implementation of the security system of FIG. 1A.

FIG. 7B is a side view of an alternate implementation of the security system of FIG. 1A.

FIG. 7C is a side view of an alternate implementation of the security system of FIG. 1A.

FIG. 8 is a plan view of an implementation of the security system of FIG. 1A.

FIG. 9 is a perspective view of a prior art security system.

Like reference symbols in the various drawings indicate like elements.

### DETAILED DESCRIPTION

This invention encompasses a tray conveyance for use with a security checkpoint. Conventional screening systems include a table positioned near a security screening device, such as an x-ray scanner. For example, FIG. 9 illustrates a typical conventional screening system 1. During screening operations, passengers approach a threshold 10, which separates a sterile area 16 from a non-sterile area 14. While approaching the threshold 10, passengers or users follow a queue 12. The queue 12 is generally positioned adjacent to a table 20, upon which one or more receptacles or trays 50 may be placed, and leads toward the threshold 10. Security screening by definition requires some type of screening for items containing characteristics largely attributable to prohibited items. For example, a screening device 30 may be an x-ray scanner or other scanning device that allows an operator to view the contents of a passenger's bag or divested items to determine if any item viewed exhibits the shape or outline of a prohibited item, such as a knife or firearm. Additionally or alternatively, a walk through screening device, such as a walk-through metal detector or other type of scanning device 32 may prevent unauthorized metal objects, such as weapons, to be carried on a screening subject's person across the threshold 10 without the knowledge of screening personnel.

During conventional screening operations, a passenger, user or “screening subject” approaches the threshold 10, and by doing so approaches the table 20. Upon reaching the table 20, subjects must often divest themselves of coats, shoes, computer bags, and other items required to be screened. Screening personnel often provide the receptacles or trays 50 for passengers to place their personal items in to ensure that they are not lost. The trays 50 may be used for spare change, wallets, car keys, coats, shoes, jackets, personal computers, mobile phones, and/or any other device or article that must be passed through a screening device.

As the subjects approach the threshold 10, they typically carry the trays 50 containing their personal items toward the scanning device 30 or slide the trays 50 along the surface of the table 20. Just prior to reaching the threshold 10, subjects place the tray(s) 50 containing their personal items onto an entry portion 34 that transports the trays 50 into the scanning device 30 through an entry curtain 38. After subjects pass through the walk-through screener 32, and have been allowed to enter the sterile area 16, they may retrieve their personal items from the trays 50 which have passed through the scanning device 30 and exited through an exit curtain 39 of the scanning device 30. Screening subjects may then retrieve their divested articles from the trays 50, and then screening personnel then retrieve the trays 50 from an exit portion 36 of the screening device 30. After obtaining the trays 50 from the exit portion 36, screening personnel typically walk across the threshold 10 from the sterile area 16 to the non-sterile area 14 and return the trays 50 to the table 20 for future use by the passengers or subjects.

As depicted in FIG. 9, the trays 50 tend to be concentrated close to the entry portion 34 of the scanning device 30. This concentration of trays 50 near the threshold increases the time required to divest because the screening subjects have a smaller portion of the tables 20 to use in the divestment process. This typically occurs because the tables 20 are the logical and closest available drop-off point in the non-sterile area 14 that allows screening subjects to access the trays 50 in the non-sterile area 14 prior to crossing the threshold 10. Accordingly, screening subjects are often rushed or hurried—or perceive a need to rush—to divest prior to screening due to the backup of other screening subjects in the queue 12 behind them. Additionally, the majority of the surface of the table 20 is left unused because screening subjects cannot acquire the trays 50 necessary to place their personal items into until they are near the entry portion 34 of the screening device 30. Aspects of the present invention substantially reduce or eliminate problems associated with conventional security screening systems.

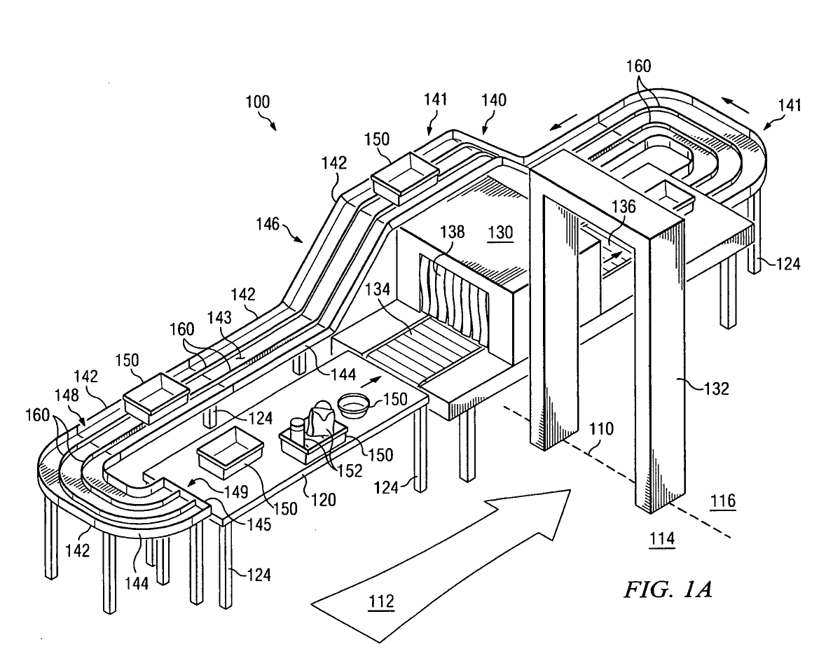

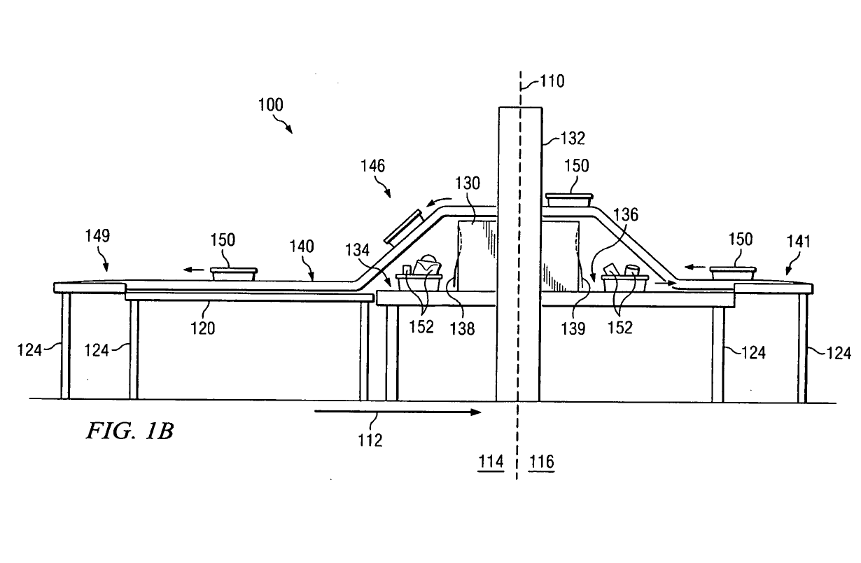

Referring to FIG. 1A, a security screening system 100 includes a threshold 110. The security screening system provides for trays or receptacles for divested personal articles to be transported to screening subjects more efficiently than previous methods. The threshold 110 may include a sterile gateway that defines a boundary between a non-sterile area 114 and a sterile area 116. For the purposes of this application, “sterile” may be defined as an area that contains only personnel and items that have passed through a security screening process to detect unauthorized or prohibited items. Alternatively, the threshold 110 may define a choke point through which a person or screening subject must pass to retrieve articles screened separate from the screening of the person of the subject. A direction of travel defines a queue 112 that serves as a divestment area. The threshold 110 may correspond to the location of one or more detection apparatus. Detection apparatus may include screening equipment such as a baggage scanner 130, a walk-through screener 132, or both, and may be operable to detect prohibited items from entering the sterile area 116 from the non-sterile area 114 across the threshold 110. Platforms or tables 120 may be located adjacent to the queue 112 to provide a user an accessible area to place items for screening during the divestment process.

For purposes of this application, “divestment” may refer to the voluntary separation by a user or passenger from any article that is required to be inspected by the governing entity, such as the Transportation Safety Administration in airports. Divestment may be required, for example, in airport terminals or government buildings where extremely sensitive detectors may be employed to detect items exhibiting characteristics of items that are prohibited from entering the terminal or interior portions of the building, respectively.

The baggage scanner 130 includes an entry portion 134 and an exit portion 136. The entry portion 134 and the exit portion 136 may be a single conveyor belt or multiple conveyor belts placed end-to-end that span the distance between the entry portion 134 and the exit portion 136. Additionally, the baggage scanner 130 includes an entry curtain 138 and an exit curtain 139. Trays 150 are provided to retain divested articles 152 for passage through the baggage scanner 130. The tables 120 may be placed near to or adjacent to the entry portion 134. A receptacle or tray return slide or “tray slide” 140 may be located near the tables 120 and/or the screener 130. In a particular implementation, the tray slide 140 may be assembled from multiple sections 142, which include a support surface 143, one or more sidewalls 144, one or more end walls 145, an elevated portion 146, and a tray conveyance 148.

The tray slide 140 and the tray conveyance 148 allow screening personnel to effectively transport the trays 150 to the screening subjects at a point in the queue 112 that allows the screening subjects to utilize a greater portion of the queue 112 for divestment than previous systems. Additionally, the tray slide 140 may be positioned in multiple configurations to match the geometry of the building or terminal in which it is placed. For example, some buildings require the screening subjects to walk down a slope to reach the threshold 110. Accordingly, the tray slides 140 may be configured in such a manner that the portion of the tray slide 140 at the threshold 110 is at a lower elevation than the retrieval portion 149 of the tray slide 140.

When the retrieval portion 149 is located at a higher elevation than the receiving portion 141, some force or mechanism must be employed so the trays 150 are moved from the receiving portion 141 to the retrieval portion 149. In such configurations, the tray slide 140 and the tray conveyance 148 may be constructed such that trays can be pushed “uphill” by screening personnel repeatedly placing the trays 150 or stacks of the trays 150 at the receiving portion 141. The tray conveyance 148 may be coupled to, or formed on a surface of, tray slide 140. In the implementation shown in FIG. 1A, the tray conveyance 148 is shown as a system of one or more rails 160 positioned longitudinally and/or along the direction of travel of tray slide 140. In this configuration, every instance in which a tray 150 or a stack of trays 150 is placed at the receiving portion 141, the previous tray 150 or stack of trays 150 are pushed along the tray slide 140 toward the retrieving portion 149. Thus, with a long line of trays 150 or stacks of trays 150, each time the line of trays 150 is moved to make room for another tray 150 at the receiving portion 141, a tray 150 or stack of trays 150 is pushed closer to the retrieval portion 149.

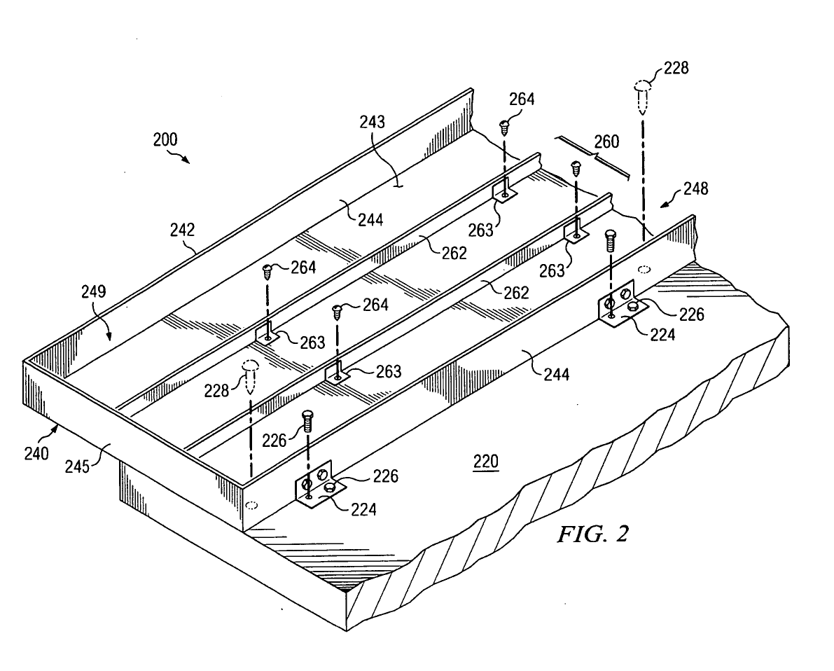

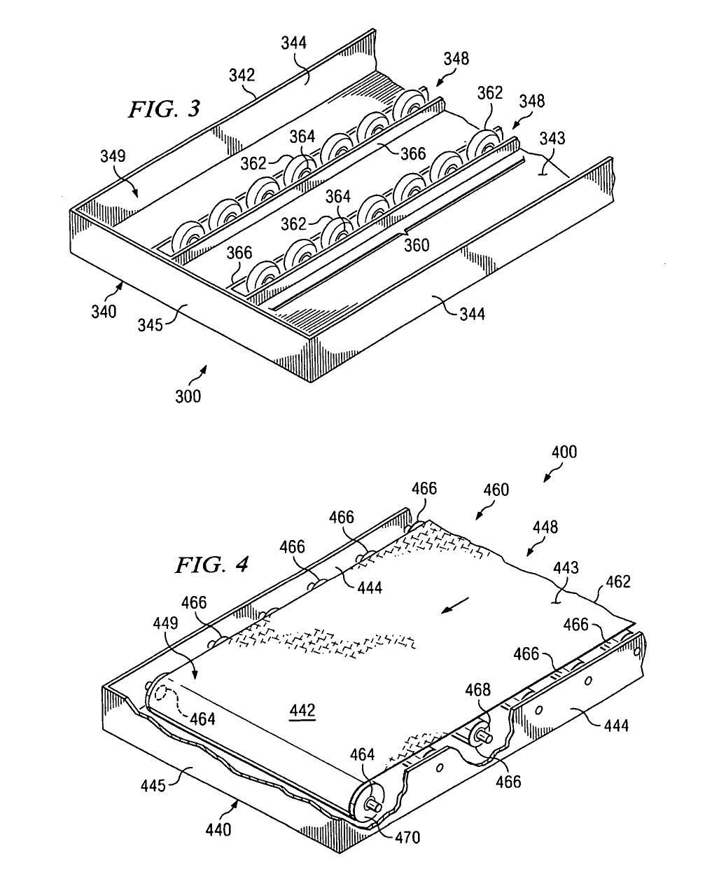

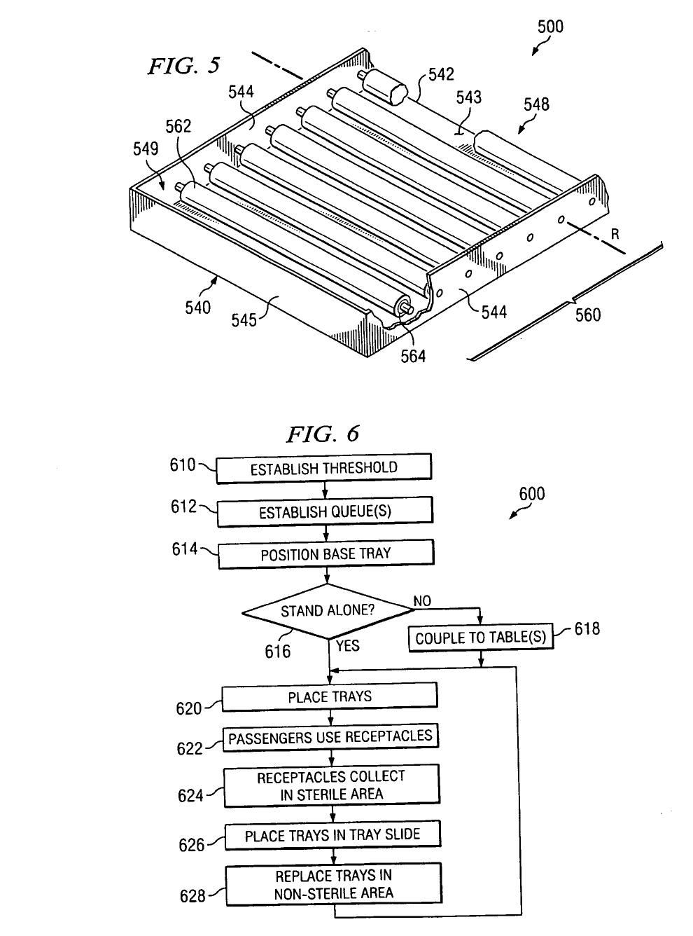

The tray conveyance 148 may be constructed of rails 160, described in greater detail as the rails 262 of FIG. 2 (see below) with a low coefficient of friction or a roller system similar to the tray conveyances 348 and 548 disclosed in FIGS. 3 and 5 below, respectively. Regardless of the specific implementation, the tray conveyance 148 facilitates the movement of the trays 150 from the receiving portion 141 to the retrieval portion 149. In cases where the tray slide 140 and the tray conveyance 148 are configured such that trays 150 move in an “uphill” direction toward the retrieval portion 149, the tray conveyance 148 can exert some force (e.g., a small amount of friction) to prevent movement of the trays 150 back toward receiving portion 141. Otherwise, the weight or force of the trays 150 that have already been placed at the receiving portion 141 and pushed upward toward the retrieval portion 149 could tend to make it difficult to place additional trays 150 into the tray slide 140. In implementations where the tray slide 140 and the tray conveyance 148 are level or are configured such that trays 150 move in a “downhill” direction toward the retrieval portion 149, such a force may not be needed. In some implementations, a powered conveyor belt may be used to transport the trays 150 from the receiving portion 141 to the retrieval portion 149.

The tray slide 140 may be a stand-alone tray slide (e.g., the tray slide 140 includes its own support legs) or the tray slide 140 may be coupled to a portion of the surface of the table or tables 120 adjacent to the queue 112. In either of these implementations, the tray slide 140 provides additional surface area for conveying trays 150 toward the retrieval portion 149 and allows the screening subject to use more of the surface area of the tables 120 for divesting and moving his or her selected tray 150 toward the entry portion 134 of the baggage scanner 130 than previous screening systems. Previous screening systems are problematic because of the clutter of trays 150 on the tables 120, which deprive screening subjects of a suitable area within which to divest.

The end wall 145 may be included in an implementation to prevent the trays 150 from being pushed or forced off of the end of the tray slide 140. Similarly, the sidewalls 144 may be included so that either a barrier exists between the tray slide 140 and the tables 120 or so that the trays 150 are maintained on the tray slide 140 until they reach the retrieval portion 149 (e.g., to prevent the trays 150 from falling off of the tray slide 140 in a direction away from the tables 120), or both.

In alternative embodiments, such as when an elevated portion 146 is at a position other than the retrieval portion 149 of the tray slide 140, the elevated portion 146 may be adapted to allow gravity to move the tray 150 and/or the article 152. For example, the elevated portion 146 may be between the receiving portion 141 and the retrieval portion 149 so that the trays 150 may be pushed toward the elevated portion 146 from the receiving portion 141 as described above, until the trays 150 reach the elevated portion 146. Upon reaching a downward-slope of the tray slide 140, the trays 150 may move under the force of gravity toward the retrieval portion 149. Additionally, the tray slide may be configured such that trays 150 may only move in one direction on the tray slide 140, such as from the sterile area 116 to the non-sterile area 114, or vice versa. The trays 150 may also be prevented from moving past a certain point, such as the threshold 110, along the tray slide 140 toward the sterile area 116 from the non-sterile area 114.

The tray conveyance 148 may be a single type of tray conveyance, such as rails, rollers, or wheels within or coupled to the tray slide 140. Alternatively, the tray conveyance 148 may be a combination of tray conveyances, such that in one implementation, rails may be used in conjunction with rollers and/or wheels, or a mechanized conveyor system may be used in conjunction with rollers, wheels, and/or rails. Regardless of the specific implementation of any tray conveyance 148, it should be understood that the tray conveyance is designed to facilitate the transportation of the trays 150 from the receiving portion 141 toward the retrieval portion 149 of the tray slide 140. The descriptions of various tray conveyances below, as well as other implementations that will be understood in light of the descriptions below, will further highlight the adaptability of various implementations of the invention.

A receiving portion 141 may be situated at a location convenient for placing the trays 150 into the tray slide 140. A retrieval portion 149 may also be included that allows a user to retrieve the trays 150 at a location near the beginning of the queue 112. Each tray slide section 142 may be straight or curved, and may also be coupled to another section 142. Additionally or alternatively, a tray slide section 142 may be coupled to a table 120 at one or more locations. (See FIG. 2). The receiving portion 141 may be located adjacent to the baggage scanner 130 or at a location adjacent to the exit portion 136 of the baggage scanner 130. The elevated portion 146 of the tray slide 140 may facilitate moving the trays 150 toward the retrieval portion 149 by imparting a gravitational potential on the trays 150 placed on the elevated portion 146.

Tray slide 140 may begin with receiving portion 141 near or adjacent to threshold 10. Alternatively, and as illustrated in FIG. 1B, tray slide 140 may span across both sides of threshold 110, with portions of tray slide 140 located in sterile area 116 and non-sterile area 114. FIG. 1B illustrates a side view of a security screening system 100 in which the receiving portion 141 is located within the sterile area 116. In the implementation illustrated, the receiving portion 141 is located adjacent to a table 120 which may be placed at the end of the exit portion 136 of the baggage scanner 130.

In operation, screening subjects that have divested and placed their articles 152 into a tray 150 for screening through the baggage scanner 130 may retrieve their articles 152 from the tray 150 upon the screening subject successfully passing through the walk-through scanner 132. In the implementation shown, screening subjects may retrieve their articles 152 at the table 120 adjacent to the exit portion 136 of the baggage screener 130 and continue about their business in the sterile area 116. Screening personnel may then either direct the screening subject to place the now-empty tray 150 into the receiving portion 141 of the tray slide 140, or the screening personnel may place the tray 150 into the receiving portion 141 of the tray slide 140 on their own.

Any number of tray conveyances 148 may be used to facilitate the movement of the trays 150 from the receiving portion 141 of the tray slide 140 in the sterile area 116 to the retrieval portion 149 of the tray slide 140 in the non-sterile area 114. For example, in the implementation shown, a motorized conveyor belt system may be used to propel the trays 150 from the receiving portion 141 to the elevated portion 146 of the tray slide 140. In this implementation, as the tray slide 140 “stacks up”, or becomes full of trays 150 directed toward the retrieval portion 149, the force of additional trays 150 placed on the motorized conveyor belt may force the trays 150 closest to the retrieval portion 149 down and away from the elevated portion 146 along the tray slide 140 toward the retrieval portion 149.

Alternatively, an end-to-end pushing system, as described above with respect to the implementation in which the retrieval portion 149 is located at an elevation greater than the receiving portion 141, may be used to propel the trays 150 to the elevated portion 146 and then down the tray slide 140 to the retrieval portion 149.

Additional implementation may include no elevated portion 146. For example, although not explicitly shown, a section 142 or multiple sections 142 of the tray slide 140 may be curved around the baggage scanner 130 (and any security screening personnel operating the baggage scanner 130) so that the trays 150 may be pushed more easily from the receiving portion 141 to the retrieval portion 149.

FIG. 2 illustrates one implementation 200 of a tray slide 140 similar to that described in connection with FIG. 1. In the illustrated portion of the tray slide 240 shown, a section 242 of the tray slide 240 includes a support surface 243, sidewalls 244, an end wall 245, retrieval portion 249, and a tray conveyance 248. In the implementation shown, the tray conveyance 248 includes a rail system 260. The rail system 260 includes one or more rails 262 coupled to the tray slide section 242 using rail brackets 263 and rail fasteners 264. The rails 262 may also be secured to the tray slide section 242 using a liquid fastener that subsequently hardens, such as glue, epoxy, or in the case of metal rails and a metal tray slide, a suitable solder or weld.

The rails 262 may also be formed or molded as part of the tray slide section 242. Any number of rails 262 with varying dimensions may be used in a given implementation. Also, any tray slide section 242 or multiple tray slide sections 242 may be coupled to the table or surface 220. Brackets 224 and tray slide fasteners 226 may be used to secure a tray slide 240 or a tray slide section 242 to the table 220. Alternatively, the tray slide 240 may be secured to the table 220 using only a fastener 228. In some implementations, the fastener 228 may be a nail, screw, bolt, rivet, or other suitable fastener. Alternatively, the tray slide section 242 may be secured to the table 220 using epoxy, glue, or other suitable hardening compound. The end wall 245 may be positioned, as illustrated to prevent any trays from being forced off of the tray slide 240 onto the floor or other unsuitable location. The sidewalls 244 may serve a similar function to that of the end wall 245, with the added advantage of preventing the trays from encroaching onto the table 220 or to another unsuitable location that interferes with the divestment process. In certain implementations, the rails 262 may be manufactured or selected based on an associated friction that the rails 262 impart to trays 150 moving along the tray slide 240. For example, in an implementation in which the trays 150 need to move more easily along the tray slide 140, rails 262 with a lower coefficient of friction may be used. Alternatively, in implementations in which the trays 150 move “uphill” along the tray slide 240, rails 262 with a greater coefficient of friction may be desirable to prevent trays 150 from sliding “downhill” as readily.

FIG. 3 illustrates another implementation 300 of a tray slide 340 and tray slide section 342. In this implementation, the tray conveyance 348 includes a skate wheel system 360. The skate wheel system 360 includes a plurality of skate wheels 362 mounted on bearings 364. The bearings 364 may be coupled to a housing 366 formed in or coupled to the tray slide section 342. Alternatively, the bearings 364 may span the entire width of the tray slide section 342 in the form of axles so that the support surface 343 of the tray slide section 342 is comprised entirely of the bearings 364 and the skate wheels 362 coupled to the sidewalls 344. Additionally, an end wall 345 may be included to stop the progression of the trays.

FIG. 4 illustrates an implementation 400 of a tray slide 440 having a tray slide section 442 with a support surface 443. The tray conveyance 448 includes a conveyor belt system 460 having a conveyor belt 462 coupled about an end roller 470. The end roller 470 may or may not include a rotational drive system to automatically move the conveyor belt 462 about the end roller 470. Additionally, the conveyor belt 462 may be coupled to an idler roller 466. The end roller 470 includes an end bearing 464 rotatably coupling the end roller to the tray slide section 442. The idler rollers 466 may be coupled to the tray slide section 242 via idler bearings 468.

In the implementation shown, the end roller 470 and idler rollers 466 are coupled directly to sidewalls 444 such that the combination of the conveyor belt 462, end roller 470 and idler rollers 466 combine to form the support surface 443. However, in alternative implementations, the end roller 470 and idler rollers 466 may be coupled to a stationary support surface 443 (not explicitly shown).

In an alternate implementation, the conveyor belt system 460 may be configured in a continuous loop, such that the trays 150 may remain on the conveyor belt system 460 throughout the security screening process. In such an implementation, the trays 150 may or may not be coupled to the conveyor belt 462. Additionally, the conveyor belt system 460 may include multiple sections of conveyor belts 462 disposed about multiple end rollers 470, each having a rotational drive system to propel the trays 150 along the tray slide 440 in the continuous loop.

FIG. 5 illustrates an implementation 500 of a tray slide 540 with a tray slide section 542. The tray slide section 542 includes a support surface 543, sidewalls 544, and a tray conveyance 548. The tray conveyance 548 includes a roller bed 560 that includes a plurality of rollers 562. The rollers 562 are coupled to the sidewalls 544 via bearings 564. Each roller 562 has a longitudinal axis corresponding to an axis of rotation R. The bearings 564 may be an axle, ball joint, or other suitable bearing assembly to allow the rollers 562 to rotate under the application of force along a direction of travel in the plane of the support surface 543.

FIG. 6 illustrates a process 600 for implementing a security system according various implementations described above. FIG. 6 is described in conjunction with the implementations illustrated by the aforementioned and described FIGS. 1-5. At step 610, a threshold, such as threshold 110 is established. The threshold 110 may be established to separate a sterile area 116 from a non-sterile area 114. At step 612, a queue 112 or multiple queues 112 are established. The queues 112 may be adapted to direct users or passengers from the non-sterile area 114 through the threshold 110 to the sterile area 116. Additionally, the queue 112 may direct passengers through a screening device, such as the walk-through screener 132.

At step 614, the tray slide 140 is positioned adjacent to or near the queue 112. Depending on cost considerations as well as considerations regarding the architecture of the building or terminal in which the screening system will be implemented, the tray slide 140 may or may not be required to be coupled to a table or tables 120. At step 616, the decision may be made to determine whether the tray slide 140 will be a stand-alone tray slide 140, or whether the tray slide 140 will be coupled to the tables 120. If, at step 616, the tray slide 140 is not a stand-alone tray slide, then at step 618 the tray slide 140 may be coupled to the table 120. The alternative implementation illustrated at FIG. 2 shows an example of a tray slide 240 coupled to a table 220 in accordance with step 616. Once the tray slide 140 has been coupled to the table 120 at step 618, or if the tray slide 140 is a stand-alone tray slide, then at step 620, the trays 150 are placed onto the tray slide 140 at the receiving portion 141, or at any suitable location along the tray slide 140.

The trays 150 may be placed onto the tray slide 140 at any suitable location, such as the receiving portion 141 or on any support surface 143 along the length of the tray slide 140. In certain implementations, such as implementations having an elevated portion 146, placing the trays 150 at an elevated portion and moving the trays 150 along the tray slide 140 away from the elevated portion 146 may impart a velocity and/or an acceleration due to gravity or other physical force that propels the trays 150 to the retrieval portion 149. Alternatively, if the tray slide 140 includes a motorized implementation such as implementation 400, then the trays 150 placed on the conveyor belt 460 of the tray slide 440 may propel the trays 150 from the receiving portion 141 to the retrieval portion 149 under the power provided by a motorized end roller 470.

At step 622, passengers may use the trays 150 by retrieving them from the retrieval portion 149 of the tray slide 140 and sliding them along the tables 120 adjacent to the queue 112, which may also serve as the divestment area. As passengers move within the queue 112 toward the threshold 110, additional passengers may retrieve the trays 150 that have moved from the receiving portion 141 to the retrieving portion 149. Upon approaching the threshold 110, passengers may be required to place the trays 150 into the baggage scanner 130 prior to walking through the walk-through screener 132 at the threshold 110. Upon successfully passing through the walk-through screener 132, the passenger may retrieve the trays 150 containing divested articles 152 from the exit portion 136 of the baggage scanner 130. Once the passenger has collected the divested articles 152 from the tray 150, at step 624, a worker such as a Transportation Safety Administration worker (in the case of airports), or any other individual or “collector” manning the threshold may collect the trays 150 from the exit portion 136 of the baggage scanner 130. After collecting the trays 150 at step 626, at step 628, the collector may transport the trays 150 to the receiving portion 140 of the tray slide 140 to replace the trays 150 removed from the tray slide 140 by the screening subjects, and thus the process 600 returns to step 620.

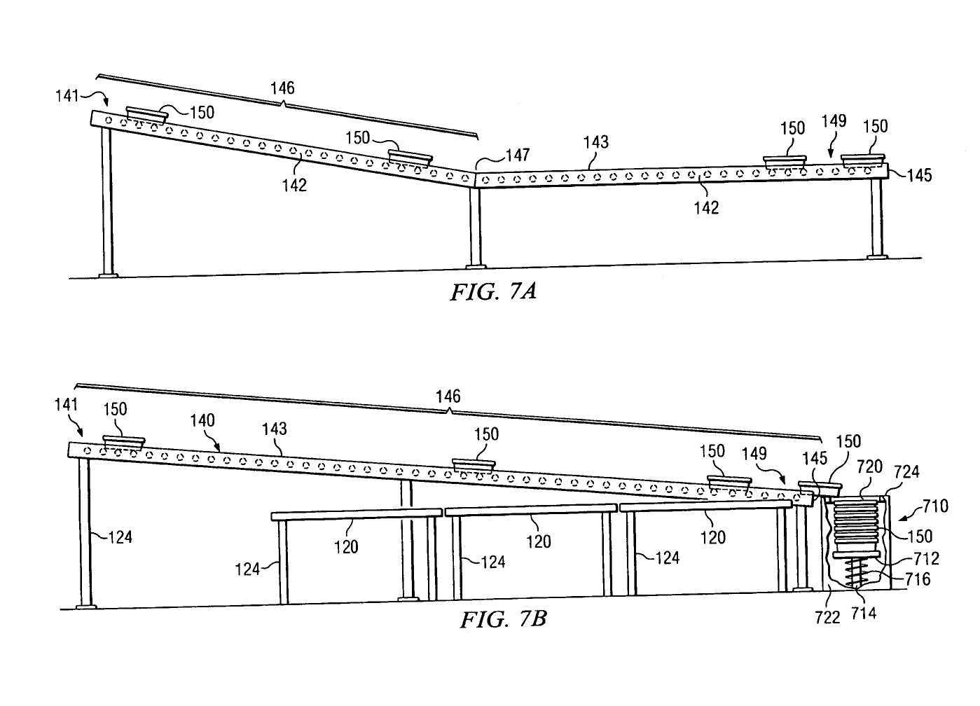

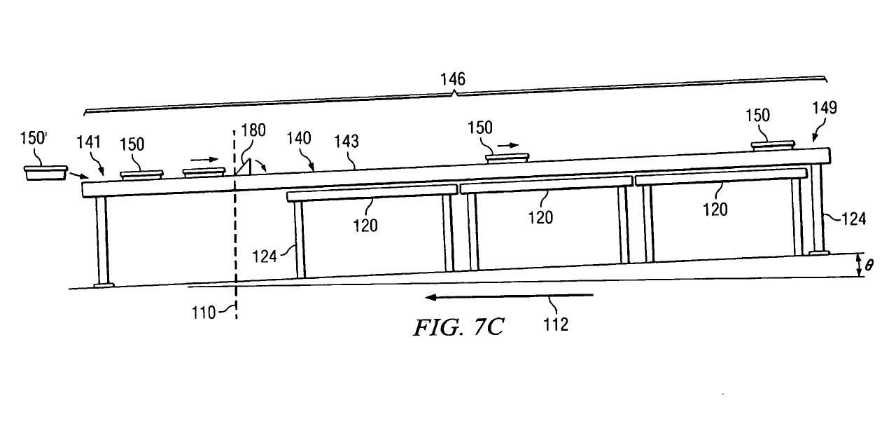

FIGS. 7A, 7B, and 7C show side views of a tray slide 140 according to an implementation to illustrate the operation of the tray slide 140 with an elevated portion 146. The elevated portion 146 of the tray slide 140 may be an individual tray slide section 142 or a unitary design with a single tray slide 140. FIG. 7A illustrates two sections 142 coupled at a joint 147. The elevated portion 146 includes the receiving portion 141, which may be at any point along the support surface 143 of the elevated portion 146. In FIG. 7A, the retrieval portion 149 is illustrated at a position distal from the elevated portion 146, although in an alternate implementation, such as the implementation illustrated in FIG. 7C, the retrieval portion 149 may be located along the support surface 143 in the elevated portion 146, so that the trays 150 on the tray slide 140 move from a lower elevation to a higher elevation at some point in the elevated portion 146.

FIG. 7B illustrates a tray slide 140 on a continuous or substantially continuous incline. In this implementation, the elevated portion 146 may include the entirety of the tray slide 140 with the exception of the retrieval portion 149. By way of example only, and not by way of limitation, the trays 150 placed at any point along the support surface 143 of the elevated portion 146 may be propelled toward the receiving portion 149 by the force of gravity. Examples of the tray conveyance 148 that includes skate wheels, a conveyor belt, or rollers, as illustrated in FIGS. 3, 4, and 5, respectively, demonstrate the operability of a gravity-driven tray slide 140 according to FIGS. 7A and 7B.

FIG. 7B also illustrates a tray dispenser 710 positioned adjacent to the retrieval portion 149 of the tray slide 140. In various implementations, the tray dispenser 710 may be used to store excess trays 150 to prevent the backup of the trays 150 along the tray slide 140. In the implementation shown, the tray dispenser 710 includes an aperture 720 in a top surface 724 of a housing 722. As trays are moved to the retrieval portion 149 and not retrieved by screening subjects, they may be allowed to drop or slide into the aperture 720. In the cutaway illustration of the housing 722 of FIG. 7B, numerous trays 150 are shown stacked upon a platform or plunger 712. The platform 712 may be supported by a support system that includes a spring 716 or a shaft 714, or both. As additional trays 150 slide into the aperture 720 of the tray dispenser 710, the trays are stacked upon or within one another and supported by the platform 712. The spring 716 may allow for the weight of additional trays 150 to force the platform 712 downward to maintain the relative height of the trays 150 stacked within the tray dispenser 710. As screening subjects remove trays 150 from the tray dispenser 710, the reduction in the weight of the stack of trays 150 allows the spring 716 to force the remaining trays 150 in the stack upward. In addition to a spring 716 and shaft 714, numerous support systems may be employed in tray dispenser 710 to maintain the relative height of the trays 150 stacked within the tray dispenser 710. For example, a weight-sensitive hydraulic system may be used to maintain the relative height of the trays 150. Additionally, a gear driven electronic platform may be used. Other support systems, such as a spring 716 without a shaft 714, will be readily ascertainable.

FIG. 7C illustrates an implementation in which the tray slide 140 and the tables 120 are configured at an incline relative to the threshold 110. The incline of the walkway upon which the tray slide 140 and the tables 120 are placed may be defined by the incline of the floor of the building or terminal in which the screening system is implemented. In the example shown, the queue 112 directs the screening subjects “downhill” toward the threshold. As the trays 150 are placed in the receiving portion 141 of the tray slide 140, previously placed trays 150 are pushed up the tray slide 140 toward the retrieval portion 149 of the tray slide 140. As additional trays 150 are placed on the tray slide 140, previously placed trays 150 may be retrieved by the screening subjects at a position more distal from the threshold 110.

The friction between the trays 150 and the tray conveyance 148 that includes rails, such as rails 262 of FIG. 2, may control the descent (or prevent the backward descent) of a tray 150 placed on the elevated portion 146 of tray slide 140 (see FIGS. 7A and 7B). Alternatively, the rails 262 may allow for the trays 150 to be progressively moved up the elevated portion 146 as additional trays are placed at receiving portion 141. Moving the trays 150 from the receiving portion 141 to the retrieval portion 149 of tray slide 140 may also be performed with the tray conveyances illustrated in FIGS. 3, 4, and 5. If a powered conveyor belt is used for the tray conveyance 148, such as conveyor belt 460 used in conjunction with a powered end roller 470 as illustrated in FIG. 4, the trays 150 may be moved up or down tray slide 140 based on the direction of travel of belt 460.

A tray stop 180 may also be included that prevents the trays from moving toward the receiving portion 141. The tray stop 180 may be movable, such as a spring-loaded tray stop 180 or a counterbalanced tray stop 180, so that when a tray 150 moves along the tray slide 140 toward the retrieval portion 149, the tray stop 180 is depressed into or toward the support surface 143. After the tray has passed over the tray stop 180, the tray stop 180 may return to an unloaded position, thus preventing the movement of the trays 150 toward the receiving portion 141. In the implementation shown, the tray stop 180 is located adjacent to the threshold 10, but in a given implementation, the tray stop 180 may be located at any suitable point along the tray slide 140.

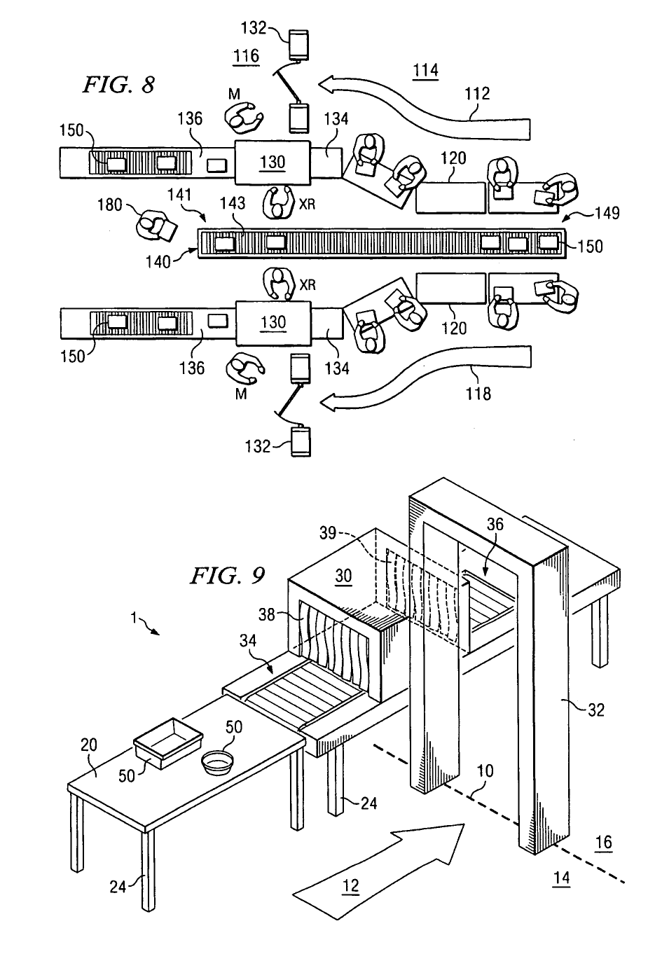

FIG. 8 illustrates yet another implementation 800 of a security system. The implementation illustrated by FIG. 8 shows the operation of multiple queues 112 and 118 serviced by a single return tray. A single tray slide 140 may be positioned between two queues 112 and 118 having associated divestment areas and tables 120 located adjacent thereto. Additionally or alternatively, a tray slide 140 may be positioned between walk-through screeners 132 or baggage screeners 130 (not explicitly shown). After the trays 150 have passed through the baggage scanners 130 at the exit portion 136, a worker or employee 180 may collect the trays 150 from the exit portion 136 of the baggage scanner 130 and place them in the receiving portion 141 of the tray slide 140. By gravity, mechanical force, or human force (either direct or by applying force to a tray 150 by placing additional trays 150 at receiving portion 141), the trays 150 move along the tray slide 140 from the receiving portion 141 to the retrieval portion 149. Passengers or users in the queues 112 and 118 may access the retrieving portion 149 to retrieve the trays 150 for use in divestment as they move along their respective queues.

A number of embodiments of the invention have been described. Nevertheless, it will be understood that various modifications may be made without departing from the spirit and scope of the invention. For example, any single tray conveyance 148 may be used with any other tray conveyance 148 to deliver the trays 150 from a receiving portion 141 to a retrieving portion 149. For example, the implementation of FIG. 2 illustrating rails 260 may be used in conjunction with any or all of the implementations of FIGS. 3, 4, and 5, illustrating a skate wheel system 360, a conveyor belt system 460, or a roller bed 560, respectively. Additionally, the tray slide sections 142 may be straight or curved to follow the direction of queue 112 or queues 112 and 118. Accordingly, other embodiments are within the scope of the following claims Various embodiments may result in numerous advantages, such as a reduction in screening time, reduction in the number of trays 150 required for the operation of screening system, and other advantages that will be apparent to those of ordinary skill in the art.

1. A system for increasing security screening efficiency comprising:
a gateway between a non-sterile area and a sterile area;
a screening queue for the sterile gateway;
a tray slide positioned adjacent to the screening queue, wherein the tray slide comprises a sidewall and a support surface, wherein the tray slide is operable to deliver a tray to a screening subject in the screening queue.

2. The system of claim 1, further comprising a tray conveyance coupled to the tray slide.

3. The system of claim 1, wherein the gateway comprises a detection apparatus, the detection apparatus adapted to detect items prohibited from entering the sterile area.

4. The system of claim 3, wherein the screening queue is defined by a direction of travel, the direction of travel operable, when followed, to direct passengers from the non-sterile area to the sterile area.

5. The system of claim 4, wherein the tray slide is coupled to a table disposed between the tray slide and the screening queue.

6. The system of claim 1, wherein the tray slide includes an elevated portion.

7. The system of claim 6, further comprising a receiving portion, the receiving portion adapted to receive trays and collocated with the elevated portion.

8. The system of claim 1, wherein the tray slide comprises a plurality of tray slide sections, each of the plurality of tray slide sections having a similar width and coupled to at least another of the plurality of tray slide sections.

9. The system of claim 2, wherein the tray conveyance comprises a roller bed.

10. The system of claim 9, wherein the roller bed comprises a plurality of wheels.

11. The system of claim 9, wherein the roller bed comprises a plurality of cylindrical rollers, each of the plurality of cylindrical rollers having a longitudinal axis, and wherein the longitudinal axis is the axis of rotation of the cylindrical rollers.

12. The system of claim 2, wherein the tray conveyance comprises a conveyor belt.

13. The system of claim 1, wherein the sidewall is affixed to the tray slide and operable to confine the tray to the tray slide.

14. The system of claim 13, wherein the sidewall comprises at least two sidewalls, the at least two sidewalls affixed to the tray slide such that each of the at least two sidewalls extend substantially the entire length of the tray slide.

15. The system of claim 6, wherein the plurality of tray slide sections comprises a plurality of rectangular-shaped sections, wherein each of the plurality of rectangular-shaped sections has substantially similar dimensions.

16. The system of claim 8, wherein the plurality of tray slide sections form a curved tray slide, wherein the curved tray slide defines a direction of travel corresponding to the screening queue.

17. The system of claim 16, wherein the screening queue comprises two screening queues.

18. The system of claim 1, further comprising a means for delivering the tray to the passenger.

19. The system of claim 18, wherein the means for delivering the tray comprises a plurality of rollers coupled to the tray slide.

20. The system of claim 18, wherein the means for delivering the tray comprises a motorized conveyor belt.

21. The system of claim 1, further comprising a table positioned between the tray slide and the screening queue.

22. The system of claim 21, wherein the tray slide is coupled to the table, and wherein a portion of the table is exposed between the tray slide and the screening queue.

23. The system of claim 1, further comprising a retrieval portion, the retrieval portion located at a portion of the tray slide distal from the gateway.

24. The system of claim 23, further comprising an end wall, the end wall positioned at the retrieval portion of the tray slide and adapted to prevent the trays from leaving an area of the tray slide bounded by the end wall and the sidewalls.

25. The system of claim 23, further comprising a tray dispenser positioned at the distal end of the tray slide from the gateway, the tray dispenser adapted to retain trays delivered to the retrieval portion.

26. The system of claim 25, wherein the tray dispenser further comprises:
an aperture adapted to allow the tray to fit at least partially therethrough;
a platform adapted to support the tray; and
a support system, the support system operable to maintain the tray at a height substantially constant in relation to the retrieval portion.

27. A system for providing security screening, comprising:
a tray slide, wherein the tray slide is operable to transport an article from a sterile area to a non-sterile area, with entry to the sterile area requiring passage through a detection device; and
a screening queue adjacent to the tray slide, wherein the screening queue defines a path from the non-sterile area to the sterile area.

28. The system of claim 27, wherein the detection device is a baggage scanner, the baggage scanner operable to detect prohibited items introduced to the sterile area, and wherein the detector is the threshold between the sterile area and the non-sterile area.

29. The system of claim 28, wherein the tray slide comprises a plurality of sections, each of the plurality of sections operable to be coupled to another of the plurality of sections.

30. The system of claim 27, wherein the tray slide comprises an elevated portion and a non-elevated portion, the elevated portion operable to impart a gravitational potential energy to an item placed on the conveyance at the elevated portion, the potential energy operable to deliver the item through the length of the elevated portion to the non-elevated portion.

31. The system of claim 27, further comprising a means for propelling the article from the sterile area to the non-sterile area.

32. The system of claim 31, wherein the means for propelling the screening tray from the sterile area to the non-sterile area comprises an elevated portion of the tray slide, the elevated portion operable to impart a gravitational potential energy to an article placed on the elevated portion of the tray slide.

33. The system of claim 32, wherein the means for propelling the article comprises:
a plurality of rollers, wherein the plurality of rollers further comprises a rotational drive mechanism for turning one of the plurality of rollers; and
a belt disposed around the plurality of rollers, wherein the belt rotates around the plurality of rollers due to the rotational force applied to the belt from the one of the plurality of rollers.

34. The system of claim 27, further comprising a table disposed between a portion of the tray slide and the screening queue, wherein the tray conveyance is coupled to the table.

35. The system of claim 27, further comprising a tray dispenser, wherein the tray dispenser is located adjacent to the retrieval portion.

36. The system of claim 35, wherein the tray dispenser is adapted to receive the tray from the tray slide.

37. The system of claim 36, the tray dispenser further comprising:
an aperture adapted to allow the tray to fit at least partially therethrough;
a platform adapted to support the tray; and
a support system, the support system operable to maintain the tray at a height substantially constant in relation to the retrieval portion.

38. A method for providing security screening comprising:
establishing a first screening queue to direct passengers from a non-sterile area to a sterile area, the screening queue comprising a start point and passing through a sterile threshold, the sterile area comprising an area to which access is controlled, wherein access to the sterile area requires screening for prohibited items through the sterile threshold;
positioning a tray slide adjacent to a divestment table, the divestment table accessible from the screening queue, the tray slide comprising a sidewall;
placing trays into the tray slide; and
facilitating movement of the trays along the tray slide toward the start point of the screening queue.

39. The method of claim 38, wherein the tray slide is coupled to the divestment table.

40. The method of claim 38, further comprising establishing a second screening queue, wherein the tray slide is disposed between the first screening queue and the second screening queue.

41. The method of claim 38, wherein the tray slide is operable to return trays from the sterile area to the non-sterile area.

42. The method of claim 38, further comprising coupling a conveyor system to the tray slide.

43. The method of claim 42, wherein the conveyor system comprises a plurality of rollers coupled to the tray slide.

44. The method of claim 43, wherein the plurality of rollers comprises a roller bed.

45. The method of claim 43, wherein the plurality of rollers comprises a plurality of skate wheels.

46. The method of claim 43, further comprising a conveyor belt disposed around the plurality of rollers.

47. The method of claim 38, wherein the tray slide is operable to return trays from a first position in the non-sterile area to a second position in the non-sterile area, wherein the first position is closer in proximity to the sterile threshold than the second position.

48. A system for increasing security screening efficiency comprising:
a gateway between a non-sterile area and a sterile area;
a screening queue for the sterile gateway;
a tray slide positioned adjacent to the screening queue, wherein the tray slide comprises a tray conveyance and a support surface, wherein the tray slide is operable to deliver a tray to a screening subject in the screening queue.

49. The system of claim 48, further comprising a sidewall coupled to the tray slide.

50. The system of claim 48, wherein the gateway comprises a detection apparatus, the detection apparatus adapted to detect items prohibited from entering the sterile area.

51. The system of claim 50, wherein the screening queue is defined by a direction of travel, the direction of travel operable, when followed, to direct passengers from the non-sterile area to the sterile area.

52. The system of claim 51, wherein the tray slide is coupled to a table disposed between the tray slide and the screening queue.

53. The system of claim 48, wherein the tray slide includes an elevated portion.

54. The system of claim 53, further comprising a receiving portion, the receiving portion adapted to receive trays and collocated with the elevated portion.

55. The system of claim 54, wherein the tray slide comprises a plurality of tray slide sections, each of the plurality of tray slide sections having a similar width and coupled to at least another of the plurality of tray slide sections.

56. The system of claim 48, wherein the tray conveyance comprises a roller bed.

57. The system of claim 56, wherein the roller bed comprises a plurality of wheels.

58. The system of claim 56, wherein the roller bed comprises a plurality of cylindrical rollers, each of the plurality of cylindrical rollers having a longitudinal axis, and wherein the longitudinal axis is the axis of rotation of the cylindrical rollers.

59. The system of claim 48, wherein the tray conveyance comprises a conveyor belt.

60. The system of claim 49, wherein the sidewall is affixed to the tray slide and operable to confine the tray to the tray slide.

61. The system of claim 60, wherein the sidewall comprises at least two sidewalls, the at least two sidewalls affixed to the tray slide such that each of the at least two sidewalls extend substantially the entire length of the tray slide.

62. The system of claim 53, wherein the plurality of tray slide sections comprises a plurality of rectangular-shaped sections, wherein each of the plurality of rectangular-shaped sections has substantially similar dimensions.

63. The system of claim 55, wherein the plurality of tray slide sections form a curved tray slide, wherein the curved tray slide defines a direction of travel corresponding to the screening queue.

64. The system of claim 63, wherein the screening queue comprises two screening queues.

65. The system of claim 48, further comprising a means for delivering the tray to the passenger.

66. The system of claim 65, wherein the means for delivering the tray comprises a plurality of rollers coupled to the tray slide.

67. The system of claim 65, wherein the means for delivering the tray comprises a motorized conveyor belt.

68. The system of claim 48, further comprising a table positioned between the tray slide and the screening queue.

69. The system of claim 68, wherein the tray slide is coupled to the table, and wherein a portion of the table is exposed between the tray slide and the screening queue.

70. The system of claim 48, further comprising a retrieval portion, the retrieval portion located at a portion of the tray slide distal from the gateway.

71. The system of claim 70, further comprising an end wall, the end wall positioned at the retrieval portion of the tray slide and adapted to prevent the trays from leaving an area of the tray slide bounded by the end wall and the sidewalls.

72. The system of claim 70, further comprising a tray dispenser positioned at the distal end of the tray slide from the gateway, the tray dispenser adapted to retain trays delivered to the retrieval portion.

73. The system of claim 72, wherein the tray dispenser further comprises:
an aperture adapted to allow the tray to fit at least partially therethrough;
a platform adapted to support the tray; and
a support system, the support system operable to maintain the tray at a height substantially constant in relation to the retrieval portion.

74. The system of claim 48, further comprising a tray stop adapted to prevent movement of trays along the tray slide.

75. The system of claim 48, wherein the tray slide forms a continuous loop.

76. A method for conducting security screening operations, comprising:
placing trays in a tray slide;
moving the trays along the tray slide toward a retrieval portion of the tray slide, wherein the retrieval portion of the tray slide is located adjacent to a queue that directs a screening subject from a non-sterile area to a sterile area, and wherein moving the trays includes directing the trays in a direction substantially opposite to the direction in which the queue directs the screening subject.

77. The method of claim 76, wherein the step of placing the trays in a tray slide includes placing the trays in a receiving portion of the tray slide, the receiving portion of the tray slide at a location distal from the retrieval portion of the tray slide.

78. The method of claim 77, wherein the receiving portion is located in the sterile area.

79. The method of claim 76, wherein the queue directs the screening subject from a sterile area to a non-sterile area through a gateway, the gateway.
